(19) United States
(12) Patent Application Publication
(10) Pub. No.: US 2016/0042256 A1
(43) Pub. Date: Feb. 11, 2016

(54) TAPE PRINTER AND METHOD OF GENERATING PRINT DATA IN TAPE PRINTER

(71) Applicant: Seiko Epson Corporation, Tokyo (JP)

(72) Inventors: Masahiro Oida, Suwa-shi (JP); Takeshi Hosokawa, Suwa-shi (JP); Junpei Watanabe, Chiyoda-ku (JP); Ayako Inoue, Chiyoda-ku (JP); Tomoko Yamada, Chiyoda-ku (JP)

(21) Appl. No.: 14/808,887

(22) Filed: Jul. 24, 2015

(30) Foreign Application Priority Data
Aug. 5, 2014 (JP) 2014-159232

(51) Int. Cl. G06K 15/02; G06K 15/00; B41J 3/407

(52) U.S. Cl. CPC G06K 15/022; B41J 3/4075; G06K 15/002

(57) ABSTRACT

Disclosed is tape printer including: a display section that selectively displays one of a plurality of evaluation images based on the number of evaluation characters placed in a first mode; a first operation section used to operate the evaluation image in a first direction; a second operation section used to operate the evaluation image in a second direction; an image change section that changes the evaluation image to another evaluation image in which the number of the evaluation characters placed in the first mode is incremented in the first direction and changes the evaluation image to another evaluation image in which the number of the evaluation characters placed in a second mode is incremented in the second direction; and a print data generation section that generates print data of the displayed evaluation image.

### CROSS REFERENCES TO RELATED APPLICATIONS

The entire disclosure of Japanese Patent Application No. 2014-159232, filed Aug. 5, 2014 is expressly incorporated by reference herein.

### BACKGROUND

1. Technical Field

The present invention relates to a tape printer that prints an evaluation image indicating an evaluation rank based on the number of evaluation characters and a method of generating print data in the tape printer.

2. Related Art

Conventionally, there has been known a label (in the form of a tape) creator that has a keyboard to input characters such as hiragana (Japanese syllabary characters), kanji (Chinese characters), and symbols, a liquid crystal display to display the characters input via the keyboard, and a thermal print mechanism to print the characters on a laminate tape that serves as a printed target (see JP-A-8-030600).

The present inventor has found the following problem. In recent years, evaluation images such as “★⋆⋆⋆⋆” (one star) and “★★★★★” (five stars) that indicate evaluation ranks based on the number of the stars “★” have been used to show the evaluation ranks of restaurants, hotels, or the like. However, users take a lot of trouble with printing the evaluation images “★⋆⋆⋆⋆” and “★★★★★” if they input “★” and “⋆” one by one with tape printers.

An advantage of an aspect of the present invention is to provide a tape printer capable of improving operability for inputting an evaluation image that indicates an evaluation rank based on the number of evaluation characters and a method of generating print data in the tape printer.

### SUMMARY

According to an aspect of the present invention, there is provided a tape printer including: a display section that selectively displays one of a plurality of evaluation images, each of which has a plurality of evaluation characters and indicates a different evaluation rank, based on the number of the evaluation characters placed in a first mode among the plurality of evaluation characters at least some of which are capable of being individually placed in one of the first mode and a second mode; a first operation section used to operate the evaluation image in a first direction oriented from one end to the other end of the evaluation image displayed on the display section; a second operation section used to operate the evaluation image in a second direction oriented from the other end to the one end of the evaluation image displayed on the display section; an image change section that changes the evaluation image to another evaluation image in which the number of the evaluation characters placed in the first mode is incremented in the first direction when the first operation section is operated in a state in which the evaluation image is displayed on the display section, and changes the evaluation image to another evaluation image in which the number of the evaluation characters placed in the second mode is incremented in the second direction when the second operation section is operated in a state in which the evaluation image is displayed on the display section; and a print data generation section that generates print data of the displayed evaluation image.

According to another aspect of the present invention, there is provided a method of generating print data in a tape printer, method including: selectively displaying one of a plurality of evaluation images, each of which has a plurality of evaluation characters and indicates an evaluation rank, based on the number of the evaluation characters placed in a first mode among the plurality of evaluation characters at least some of which are capable of being individually placed in one of the first mode and a second mode; changing the evaluation image to another evaluation image in which the number of the evaluation characters placed in the first mode is incremented in a first direction when a first operation section is operated in a state in which the evaluation image is displayed on the display section, the first operation section being used to operate the evaluation image in the first direction oriented from one end to the other end of the evaluation image displayed on the display section; changing the evaluation image to another evaluation image in which the number of the evaluation characters placed in the second mode is incremented in a second direction when a second operation section is operated in a state in which the evaluation image is displayed on the display section, the second operation section being used to operate the evaluation image in the second direction oriented from the other end to the one end of the evaluation image displayed on the display section; and generating print data of the displayed evaluation image.

According to the configurations, the tape printer changes the evaluation image to another evaluation image in which the number of the evaluation characters placed in the first mode is incremented in the first direction when the first operation section used to operate the evaluation image in the first direction is operated in a state in which the evaluation image is displayed on the display section. In addition, the tape printer changes the evaluation image to another evaluation image in which the number of the evaluation characters placed in the second mode is incremented in the second direction when the second operation section used to operate the evaluation image in the second direction is operated in a state in which the evaluation image is displayed on the display section. Therefore, a user is allowed to intuitively perform an operation to change the evaluation image selectively displayed on the display section with the first operation section and the second operation section. Accordingly, the tape printer may improve operability for inputting the evaluation image that indicates the evaluation rank based on the number of the evaluation characters.

In this case, the first operation section preferably includes a first cursor operation section used to move a cursor displayed on the display section in the first direction, and the second operation section preferably includes a second cursor operation section used to move the cursor displayed on the display section in the second direction.

According to the configuration, the tape printer may change the evaluation image with the first cursor operation section and the second cursor operation section. Therefore, there is no need to provide a dedicated operation section to change the evaluation image independently of the first cursor operation section and the second cursor operation section.

In this case, the tape printer preferably further includes: a third cursor operation section used to move the cursor displayed on the display section in a third direction different from the first direction and the second direction; and a fourth cursor operation section used to move the cursor displayed on the display section in a fourth direction different from the first direction, the second direction, and the third direction. In the tape printer, the first cursor operation section and the third cursor operation section are preferably used to switch a selected one of a plurality of alternatives to another alternative next to the selected alternative in the first direction, the plurality of alternatives being displayed side by side in a same direction as an arrangement direction of the plurality of evaluation characters. In addition, the second cursor operation section and the fourth cursor operation section are preferably used to switch the selected one of the plurality of alternatives to another alternative next to the selected alternative in the second direction. Moreover, the image change section does not preferably change the evaluation image when the third cursor operation section is operated and does not preferably change the evaluation image when the fourth cursor operation section is operated in a state in which the evaluation image is displayed on the display section.

In the tape printer, it is also assumed to assign a function to change the evaluation image to the third cursor operation section and the fourth cursor operation section that function like the first cursor operation section and the second cursor operation section when an alternative is displayed on the display section. However, the user has difficulty in finding whether the evaluation image is changed to another evaluation image in which the number of the evaluation characters placed in the first mode is incremented in the first direction or is changed to another evaluation image in which the number of the evaluation characters placed in the second mode is incremented in the second direction when operating the third cursor operation section used to move the cursor in the third direction not coincident with the arrangement direction of the evaluation characters in a state in which the evaluation image is displayed on the display section. As a result, there is a likelihood that the evaluation image is changed despite a user's intention. The same applies to the fourth cursor operation section.

In this regard, the tape printer with the configuration does not change the evaluation image even if the user operates the third cursor operation section and the fourth cursor operation section in a state in which the evaluation image is displayed on the display section. Thus, the tape printer may prevent the evaluation image from being changed despite a user's intention.

In this case, the tape printer preferably further includes a plurality of numeric operation sections used to individually input a plurality of types of numeric characters. In the tape printer, when one of the plurality of the numeric operation sections is operated in a state in which the evaluation image is displayed on the display section, the image change section preferably changes the evaluation image to another evaluation image in which the evaluation characters corresponding to a numeric character of the operated numeric operation section are placed in the first mode.

According to the configuration, the tape printer changes the evaluation image with the operation of the numeric keys. Accordingly, the user is allowed to change the evaluation image by simply operating the numeric keys.

In this case, the image change section does not preferably change the evaluation image to another evaluation image in which the number of the evaluation characters placed in the first mode is minimum when the first operation section is operated in a state in which the evaluation image in which the number of the evaluation characters placed in the first mode is maximum is displayed on the display section, and does not preferably change the evaluation image to another evaluation image in which the number of the evaluation characters placed in the first mode is maximum when the second operation section is operated in a state in which the evaluation image in which the number of the evaluation characters placed in the first mode is minimum is displayed on the display section.

According to the configuration, the tape printer changes the evaluation image in a non-cyclic way with the operation of the first direction operation section and the second direction operation section. Thus, for example, even in a case in which the user falsely operates the first direction operation section five times when being initially aimed at operating the first direction operation section four times to change the evaluation image to another evaluation image in which the number of the evaluation characters placed in the first mode is maximum, the tape printer may change the evaluation image to another evaluation image in which the number of the evaluation characters placed in the first mode is maximum rather than changing the same to another evaluation image in which the number of the evaluation characters placed in the first mode is minimum.

### BRIEF DESCRIPTION OF THE DRAWINGS

FIG. 1 is a perspective view of a tape printer according to an embodiment of the present invention when seen from its front side.

FIG. 2 is a perspective view of the tape printer when seen from its back side.

FIG. 3 is a perspective view of the tape printer with its cover body removed.

FIGS. 4A to 4E are diagrams for describing an evaluation image printed in a rank label creation menu.

FIG. 5 is a diagram showing a hardware configuration example of the tape printer.

FIG. 6 is a diagram showing a function configuration example of the tape printer.

FIG. 7 is a flowchart of the rank label creation menu.

FIG. 8 is a flowchart of pictogram setting processing.

FIG. 9 is a flowchart of title setting processing.

FIG. 10 is a flowchart of rank setting processing.

FIG. 11 is a flowchart of print data generation processing.

FIG. 12 is a diagram showing screen transition in the rank label creation menu.

FIGS. 13A to 13E are diagrams showing screen transition in the rank setting processing.

FIG. 14 is a diagram showing screen transition on an edit screen.

### DESCRIPTION OF EXEMPLARY EMBODIMENTS

Hereinafter, a description will be given of a tape printer according to an embodiment of the present invention with reference to the accompanying drawings.

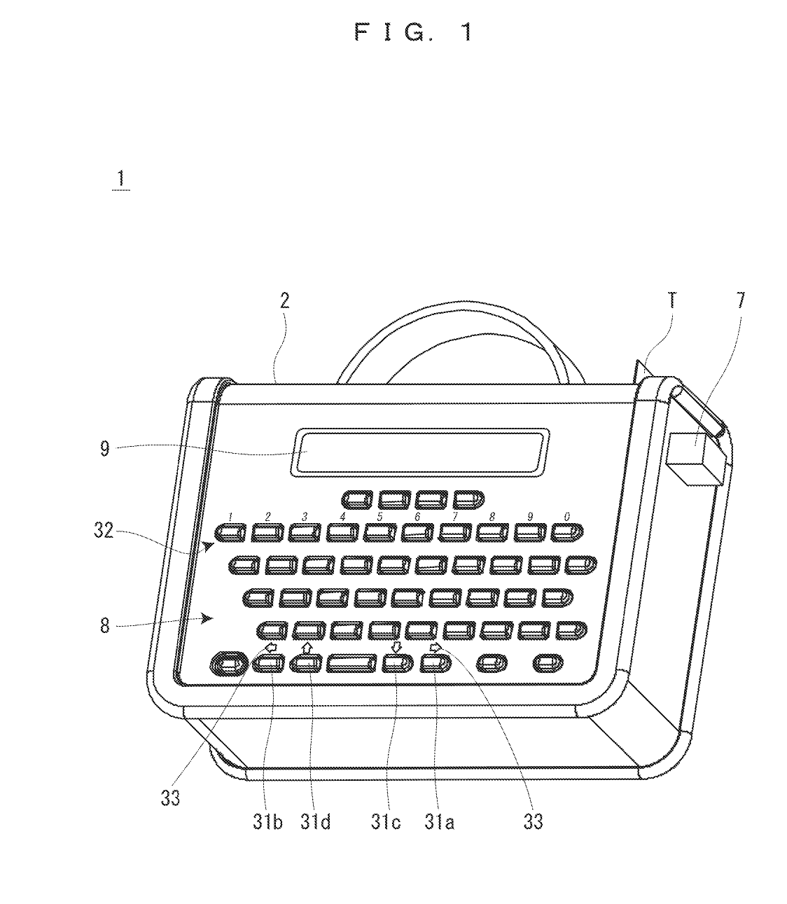

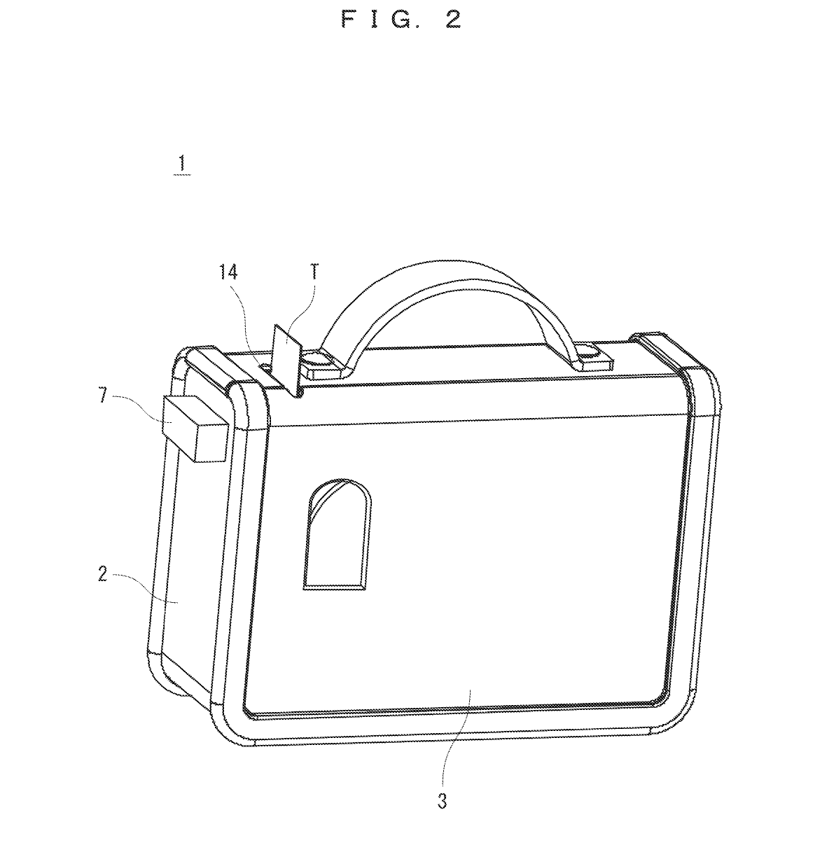

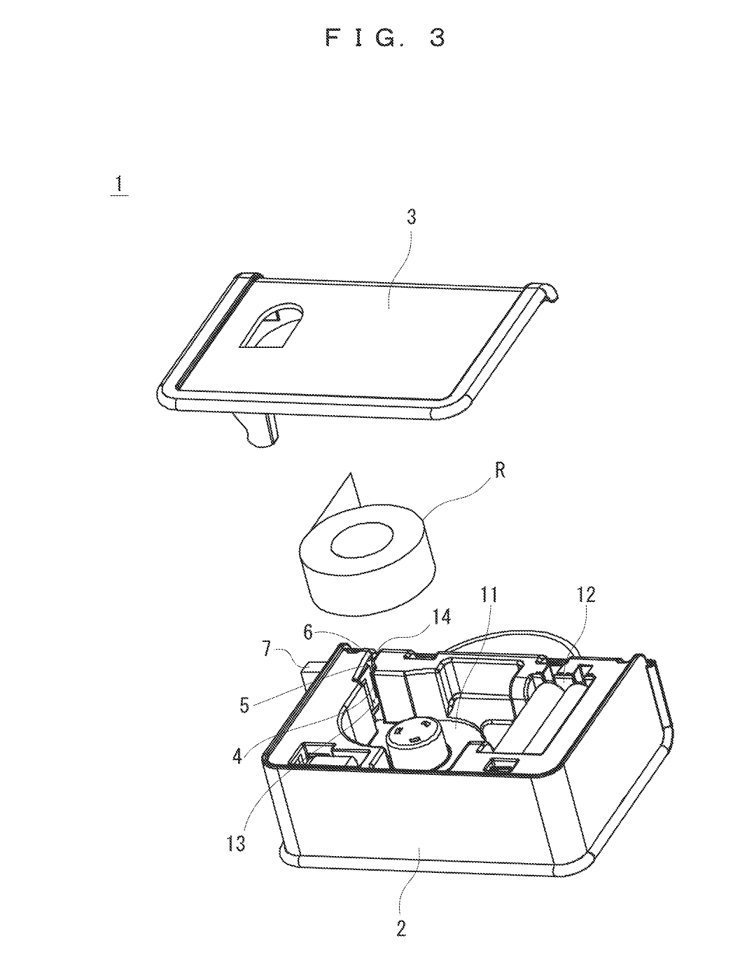

As shown in at least one of FIGS. 1 to 3, a tape printer 1 has a printer case 2, a cover body 3, a platen roller 4, a print head 5, a tape cutter 6, and a cutter button 7.

The printer case 2 forms the outer shell of the tape printer 1. The printer case 2 has a keyboard 8 and a display 9 on its front side.

Note that the display 9 is an example of a “display section.”

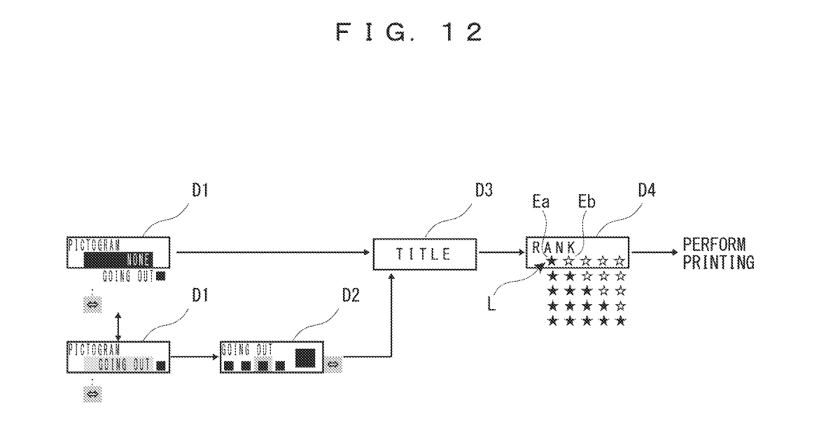

The display 9 displays a result input with the keyboard 8 or the like. A user inputs desired characters, symbols, or the like via the keyboard 8 while confirming an input result on the display 9. An evaluation image L that will be described later is displayed on the display 9 (see FIG. 12). Five stars E (★ or ⋆) that constitute the evaluation image L are displayed side by side in a lateral direction (right and left direction). Note that each of the stars E is an example of an “evaluation character.”

The keyboard 8 accepts an input operation from the user. The keyboard 8 has character keys to input characters and symbols, cursor keys 31 to move a cursor and switch an alternative, a selection key to select an alternative, a print key to perform printing, a rank level creation key to start a rank level creation menu that will be described later, or the like. The character keys include numeric keys 32 to input ten types of the numbers of “1” to “0.”

Note that each of the numeric keys 32 is an example of a “numeric operation section.”

The cursor keys 31 have a right cursor key 31a, a left cursor key 31b, a lower cursor key 31c, and an upper cursor key 31d. The right cursor key 31a, the left cursor key 31b, the lower cursor key 31c, and the upper cursor key 31d move the cursor displayed on the display 9 in a right direction, a left direction, a lower direction, and an upper direction, respectively. On each of the right cursor key 31a, the left cursor key 31b, the lower cursor key 31c, and the upper cursor key 31d, an arrow 33 that indicates a direction to move the cursor is displayed. The right cursor key 31a indicates the direction from the left end to the right end of the evaluation image L displayed on the display 9, i.e., the right direction with the arrow 33 provided thereon. On the other hand, the left cursor key 31b indicates the direction from the right end to the left end of the evaluation image L displayed on the display 9, i.e., the left direction with the arrow 33 provided thereon.

Note that the right cursor key 31a is an example of a “first cursor operation section (first operation section).” The left cursor key 31b is an example of a “second cursor operation section (second operation section).” The lower cursor key 31c is an example of a “third cursor operation section.” The upper cursor key 31d is an example of a “fourth cursor operation section.”

As will be described in detail later, the right cursor key 31a and the left cursor key 31b are also used to change the evaluation image L. In addition, the right cursor key 31a and the lower cursor key 31c are used to switch an alternative, which has been selected from among a plurality of alternatives displayed side by side in the lateral direction on the display 9, to another alternative on the right side of the selected alternative. The left cursor key 31 and the upper cursor key 31d are used to switch an alternative, which has been selected from among a plurality of alternatives displayed side by side in the lateral direction on the display 9, to another alternative on the left side of the selected alternative.

The printer case 2 has a roll installation portion 11, a battery accommodation portion 12, and a feed path 13 on its back side. In addition, the printer case 2 has a tape ejection port 14 on its lateral side.

In the roll installation portion 11, a small-wound tape roll R is installed. The tape roll R is constituted by a long tape Tp wound up in a roll shape so as to form a hole with a prescribed size at its axis. The tape Tp has a tape main body and a separation tape. The tape main body is constituted by a thermal paper. The tape Tp includes a plurality of types in which the front surfaces of the tape main bodies are different in color and design. Note that although the width of the tape Tp is not particularly limited, it is, for example, about 15 mm.

The feed path 13 is provided between the roll installation portion 11 and the tape ejection port 14. The tape Tp fed out from the roll installation portion 11 is ejected from the tape ejection port 14 to the outside of the tape printer 1 via the feed path 13.

The cover body 3 is provided on the back side of the printer case 2. The cover body 3 covers the roll installation portion 11, the battery accommodation portion 12, and the feed path 13. The user opens/closes the cover body 3 at the installation of the tape roll R, the replacement of batteries, or the like.

The platen roller 4 rotates with a feed motor 15 as a drive source. The platen roller 4 feeds the tape Tp held between the platen roller 4 and the print head 5 by rotation. The print head 5 prints images of characters on the tape Tp. The print head 5 is provided so as to face the platen roller 4 across the feed path 13. The print head 5 is of a thermal type. The print head 5 is heated and driven to print images of characters on the tape Tp fed along the feed path 13. The respective images are expressed in the form of a bitmap font.

Note that the characters represent a concept including texts, symbols, graphics, or the like. Pictograms B and the stars E that will be described later are also included in the characters.

The tape cutter 6 is provided on the downstream side of the platen roller 4 and the print head 5. The tape cutter 6 performs a cut operation to cut off the tape Tp in its width direction. The cutter button 7 is used to cause the tape cutter 6 to perform the cut operation according to a manual operation. When the tape cutter 6 performs the cut operation, a printed part of the tape Tp is cut off to create a label A.

Next, a description will be given of the rank level creation menu as one of print menus prepared in the tape printer 1 and the label A (rank label) created according to the print menu.

The tape printer 1 creates the label A on which a pictogram B, a text C, and the evaluation image L are printed according to the rank label creation menu.

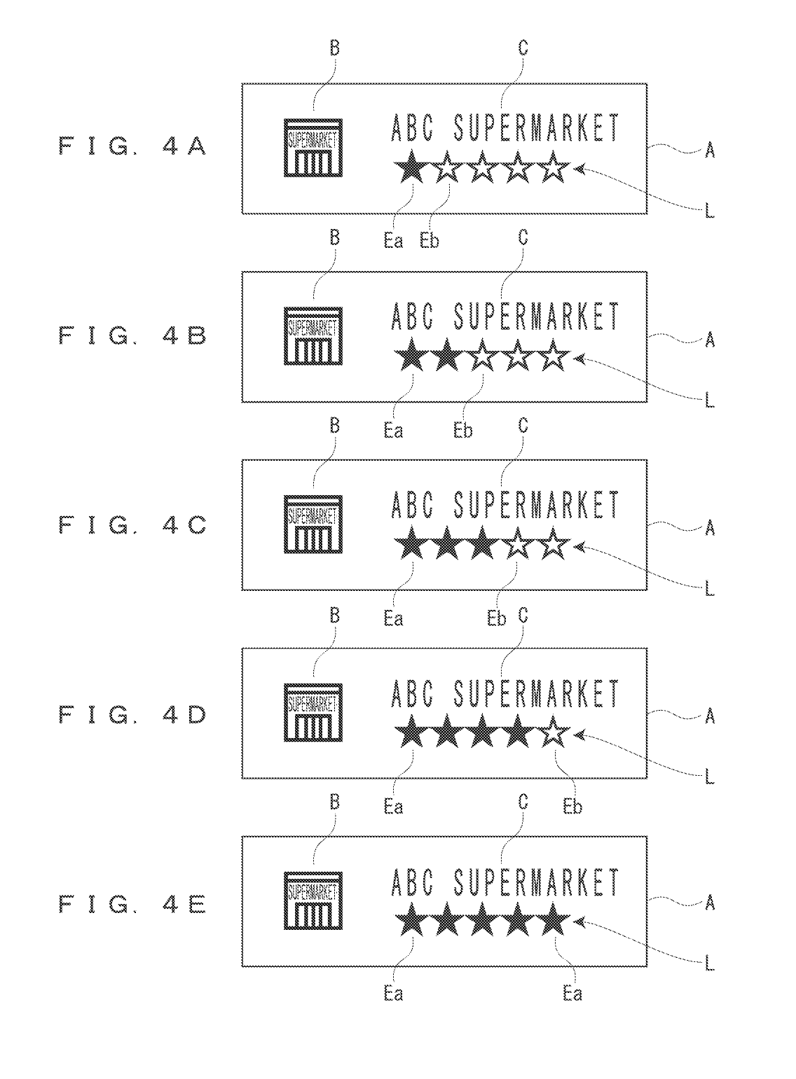

As shown in FIGS. 4A to 4E, the evaluation image L includes the five stars E arranged side by side. Among the five stars E, each of the four stars E on the right side may be placed in one of a first mode (★) in which the star E is coated with paint and a second mode (⋆) in which the star E is printed in white. Note that the stars E (★) placed in the first mode will be called first stars Ea and the stars E (⋆) placed in the second mode will be called second stars Eb. The stars (★) and the stars (⋆) will be simply called the stars E when they are not required to be distinguished from each other.

The evaluation image L indicates an evaluation rank (rank) based on the number of the first stars Ea (★). As shown in FIGS. 4A to 4E, the tape printer 1 is capable of printing the five ranks of the evaluation images L in total, i.e., the evaluation image L in which the number of the first stars Ea (★) is one, the evaluation image L in which the number of the first stars Ea (★) is two, the evaluation image L in which the number of the first stars Ea (★) is three, the evaluation image L in which the number of the first stars Ea (★) is four, and the evaluation image L in which the number of the first stars Ea (★) is five. Note that the tape printer 1 may omit one of or both the pictogram B and the text C to perform printing in the rank label creation menu.

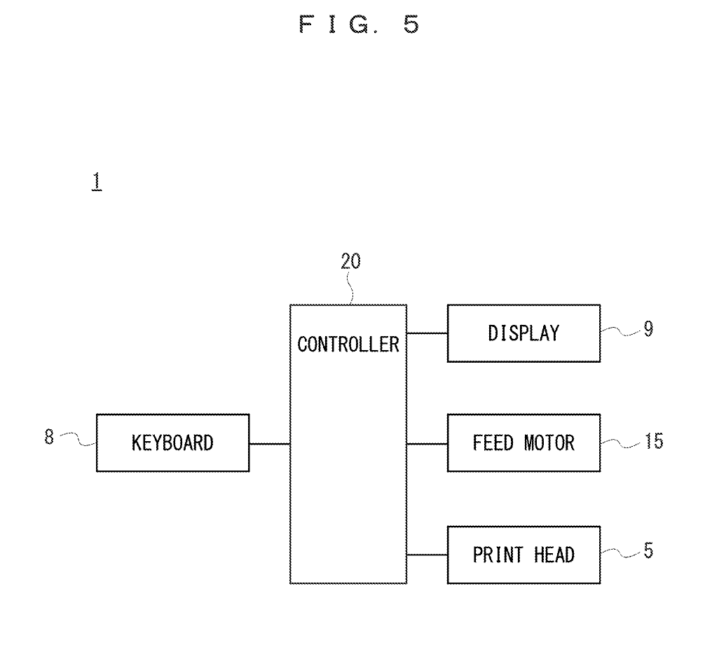

A description will be given of a hardware configuration example of the tape printer 1 with reference to FIG. 5. The tape printer 1 has a controller 20, besides the print head 5, the keyboard 8, the display 9, and the feed motor 15 described above.

The controller 20 is constituted by a CPU (Central Processing Unit), a ROM (Read Only Memory), a RAM (Random Access Memory), or the like not shown. The CPU of the controller 20 loads a program from the ROM and performs the same with the RAM to control the entire operation of the tape printer 1.

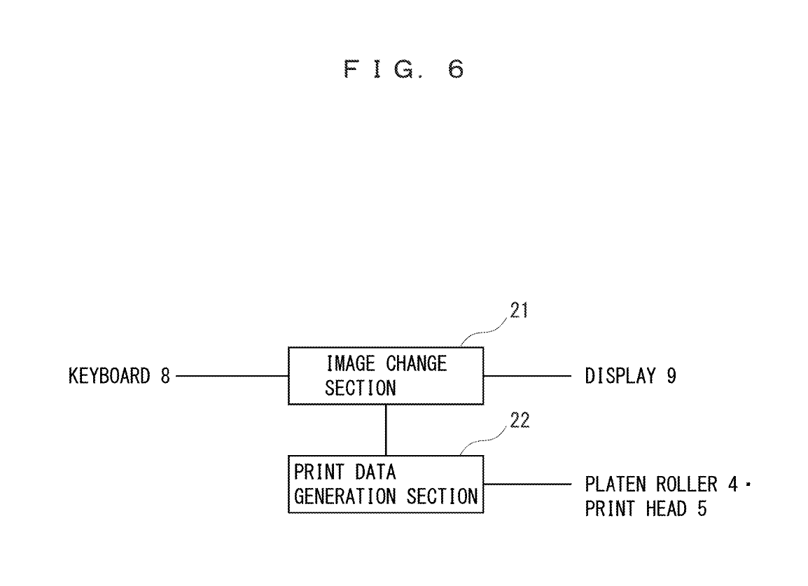

A description will be given of a function configuration example of the tape printer 1 with reference to FIG. 6. At least some of an image change section 21 and a print data generation section 22 shown in FIG. 6 are implemented when the controller 20 shown in FIG. 5 performs a prescribed program.

The tape printer 1 has the image change section 21 and the print data generation section 22. The image change section 21 displays a rank setting screen D4 (see FIG. 12) that will be described later on the display 9. On the rank setting screen D4, the five types of the evaluation images L are selectively displayed. The image change section 21 changes the evaluation image L to the evaluation image L that has a different number of the first stars Ea (★) based on the right cursor key 31a and the left cursor key 31b on the rank setting screen D4. The print data generation section 22 generates the print data of the evaluation image L or the like.

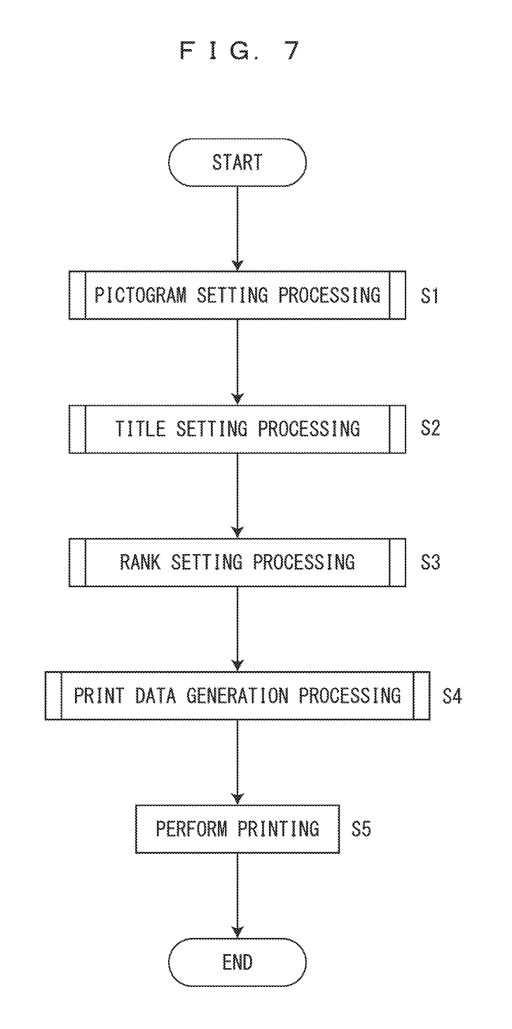

As shown in FIG. 7, the tape printer 1 successively performs pictogram setting processing (S1), title setting processing (S2), rank setting processing (S3), and print data generation processing (S4) when the user operates the rank label creation key to start the rank label creation menu. The tape printer 1 sets the pictogram B, which is to be printed on the tape Tp, in the pictogram setting processing. The tape printer 1 sets the text C, which is to be printed on the tape Tp, in the title setting processing. The tape printer 1 sets the evaluation image L, which is to be printed on the tape Tp, in the rank setting processing. That is, the number (rank) of the first stars Ea (★) of the evaluation image L is set in the rank setting processing. The tape printer 1 generates the print data of the pictogram B, the text C, and the evaluation image L set described above in the print data generation processing. After that, the tape printer 1 performs printing based on the print data (S5), creates the label A on which the evaluation image L and the like are printed, and ends the rank label creation menu. Hereinafter, each of the processing will be described.

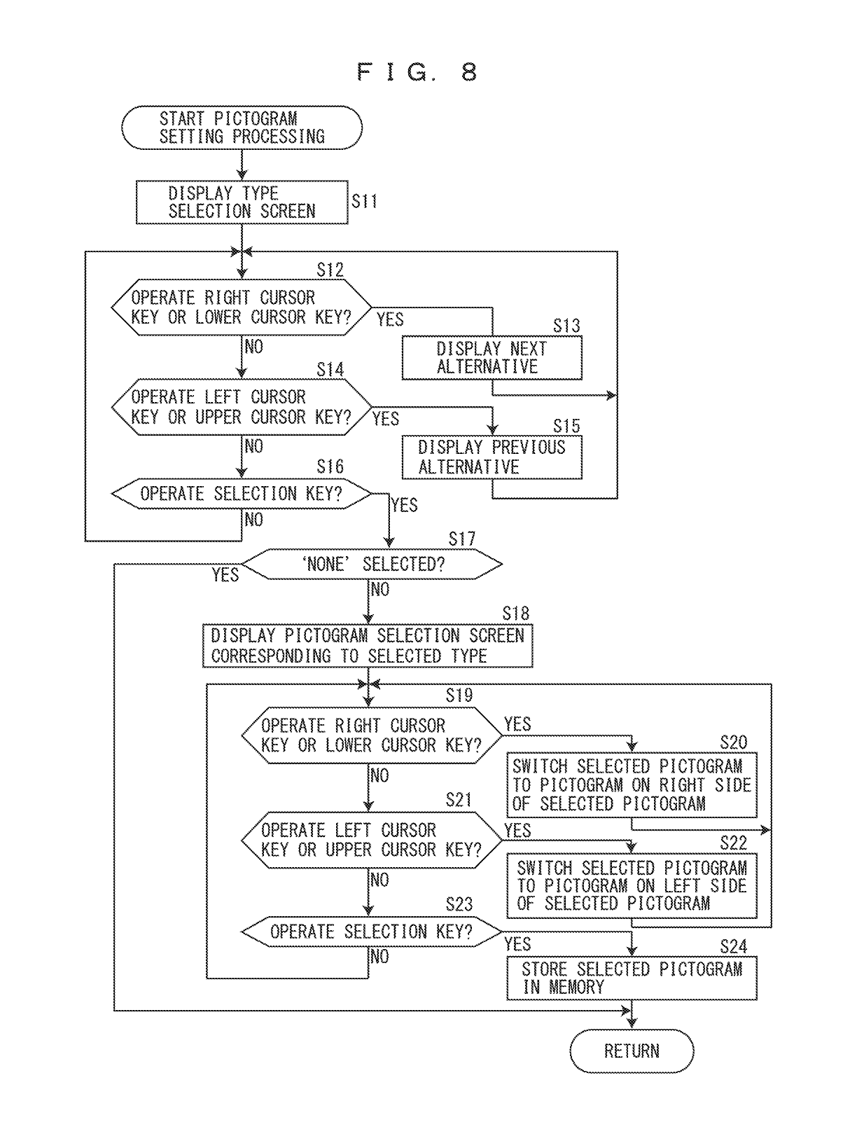

As shown in FIG. 8, the tape printer 1 displays a type selection screen D1 (see FIG. 12) on the display 9 with the start of the pictogram setting processing (S11). On the type selection screen D1, one of a plurality of alternatives such as “going out” is displayed as a type of the pictogram B in a cyclic way. When the user operates the right cursor key 31a or the lower cursor key 31c on the type selection screen D1 (S12; Yes), the tape printer 1 displays a next alternative on the type selection screen D1 (S13) and then returns to step S12. On the other hand, when the user operates the left cursor key 31b or the upper cursor key 31d on the type selection screen (S14; Yes), the tape printer 1 displays a previous alternative on the type selection screen D1 (S15) and then returns to step S12.

When the user operates the selection key on the type selection screen D1 (S16; Yes), the tape printer 1 determines whether the user has selected “none” as an alternative of the type (S17). When the tape printer 1 determines that the user has not selected “none” (S17; No), the tape printer 1 displays a pictogram selection screen D2 (see FIG. 12) corresponding to a selected type on the display 9 (S18). On the pictogram selection screen D2, four of a plurality of pictograms B that belong to the selected type are displayed in a cyclic way. Among the four pictograms B, the pictogram B on the third place from the left is highlighted in reverse video as a selected one. When the user operates the right cursor key 31a or the lower cursor key 31c on the pictogram selection screen D2 (S19; Yes), the tape printer 1 switches the selected pictogram B to the pictogram B on the right side of the selected pictogram B (S20) and then returns to step S19. On the other hand, when the user operates the left cursor key 31b or the upper cursor key 31d on the pictogram selection screen D2 (S21; Yes), the tape printer 1 switches the selected pictogram B to the pictogram B on the left side of the selected pictogram B (S22) and then returns to step S19.

When the user operates the selection key on the pictogram selection screen D2 (S23; Yes), the tape printer 1 stores the selected pictogram B in a memory (S24) and then returns to the rank label creation menu. On the other hand, when it is determined in step S17 that the user has selected “none,” the tape printer 1 returns to the rank label creation menu without setting the pictogram B. In this case, the tape printer 1 does not print the pictogram B on the tape Tp.

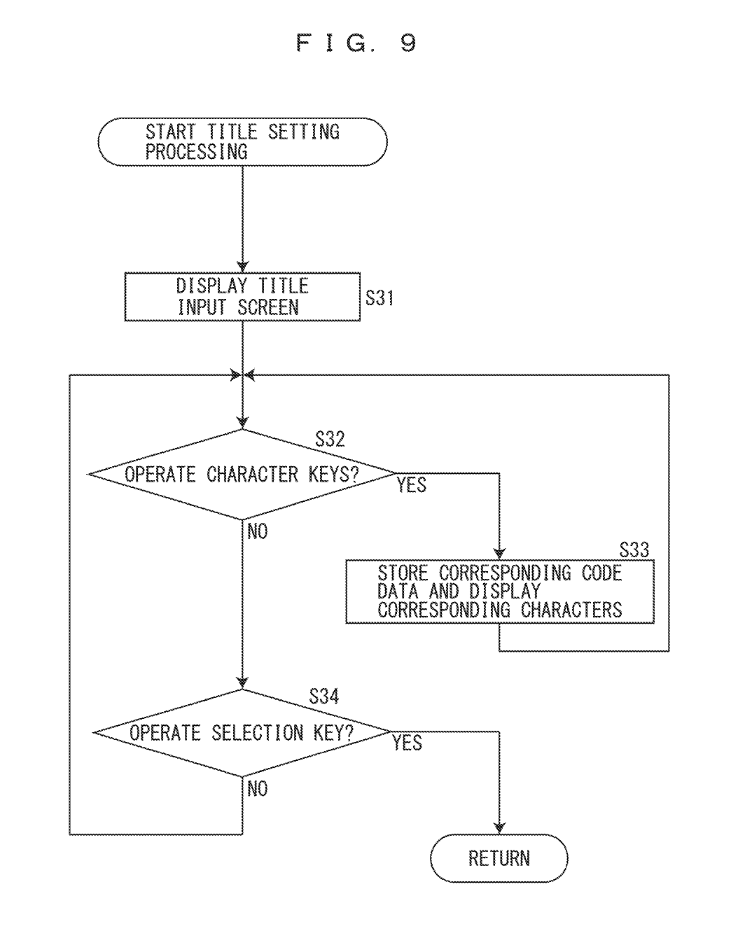

As shown in FIG. 9, the tape printer 1 displays a title input screen D3 (see FIG. 12) on the display 9 with the start of the title setting processing (S31). When the user operates the character keys on the title input screen D3 (S32; Yes), the tape printer 1 displays characters corresponding to the operated character keys on the title input screen D3 while storing code data corresponding to the operated character keys in the memory (S33) and then returns to step S32. When the user operates the selection key on the title input screen D3 (S34; Yes), the tape printer 1 ends the title setting processing and returns to the rank label creation menu.

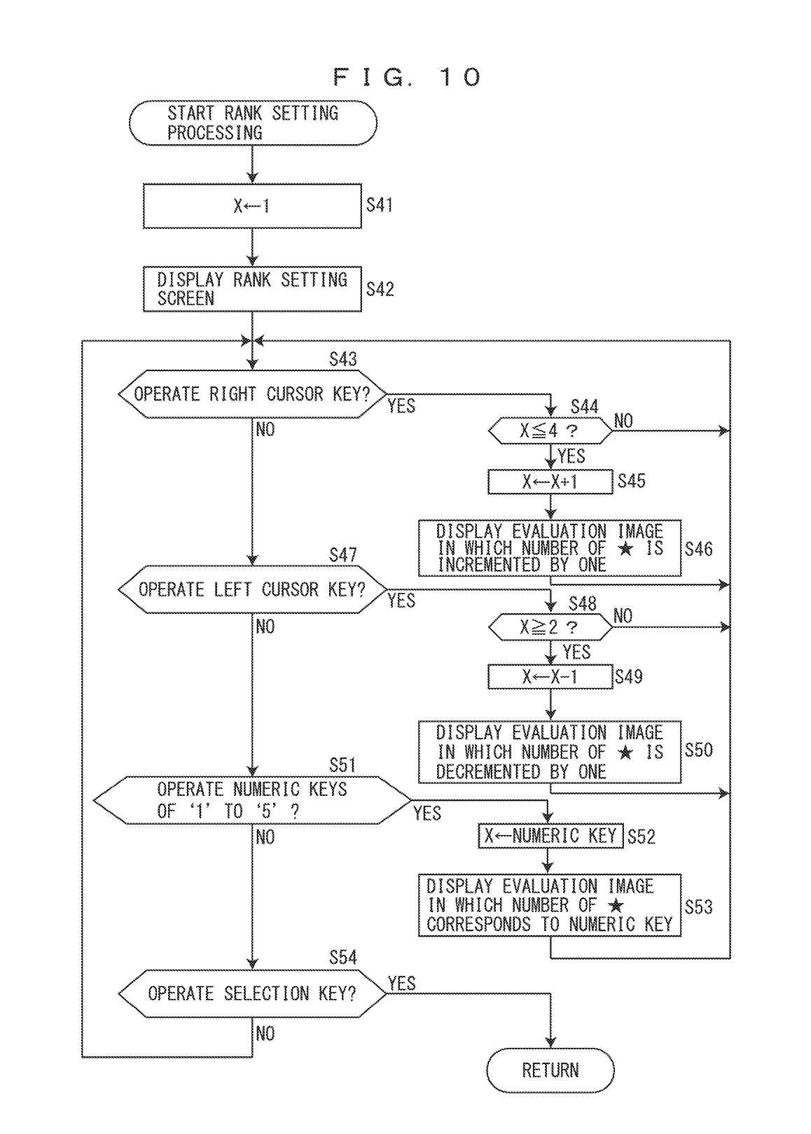

As shown in FIG. 10, the image change section 21 initializes a variable X stored in the memory to one with the start of the rank setting processing (S41). The variable X is equivalent to the number of the first stars Ea (★) of the evaluation image L. Subsequently, the image change section 21 displays the rank setting screen D4 (see FIG. 12) on the display 9 (S42). On the rank setting screen D4, the evaluation image L in which the number of the first stars Ea (★) is one is displayed as an initial display.

When the user operates the right cursor key 31a on the rank setting screen D4 (S43; Yes), the image change section 21 determines whether the variable X is four or less (S44). When it is determined that the variable X is four or less (S44; Yes), the image change section 21 increments the variable X (S45). That is, when the user operates the right cursor key 31a in a state in which the evaluation image L in which the number of the first stars Ea (★) is four or less is displayed, the image change section 21 changes the evaluation image L to the evaluation image L in which the number of the first stars Ea (★) is incremented by one (in other words, the evaluation image L in which the number of the first stars Ea (★) is incremented by one in the right direction). The image change section 21 displays the changed evaluation image L on the rank setting screen D4 (S46) and returns to step S43. On the other hand, when it is determined that the variable X is not four or less (S44; No), the image change section 21 returns to step S43. That is, the image change section 21 does not change the evaluation image L even if the user operates the right cursor key 31a in a state in which the evaluation image L in which the number of the first stars Ea (★) is five is displayed.

When the user operates the left cursor key 31b on the rank setting screen D4 (S47; Yes), the image change section 21 determines whether the variable X is two or more (S48). When it is determined that the variable X is two or more (S48; Yes), the image change section 21 decrements the variable X (S49). That is, when the user operates the left cursor key 31b in a state in which the evaluation image L in which the number of the first stars Ea (★) is two or more is displayed, the image change section 21 changes the evaluation image L to the evaluation image L in which the number of the first stars Ea (★) is decremented by one (in other words, the evaluation image L in which the number of the second stars Eb (⋆) is incremented by one in the left direction). The image change section 21 displays the changed evaluation image L on the rank setting screen D4 (S50) and returns to step S43. On the other hand, when it is determined that the variable X is not two or more (S48; No), the image change section 21 returns to step S43. That is, the image change section 21 does not change the evaluation image L even if the user operates the right cursor key 31a in a state in which the evaluation image L in which the number of the first stars Ea (★) is one is displayed. Thus, the five types of the evaluation images L are changed on the rank setting screen D4 in a non-cyclic way.

When the user operates one of the numeric keys 32 of “1” to “5” on the rank setting screen D4 (S51), the image change section 21 updates the variable X to the value of the operated numeric key 32 (S52). That is, the image change section 21 changes the evaluation image L to the evaluation image that has the first stars Ea (★) corresponding to the operated numeric key 32. The image change section 21 displays the changed evaluation image L on the rank setting screen D4 (S53) and returns to step S43.

When the user operates the selection key on the rank setting screen D4 (S54; Yes), the tape printer 1 ends the rank setting processing and returns to the rank label creation menu.

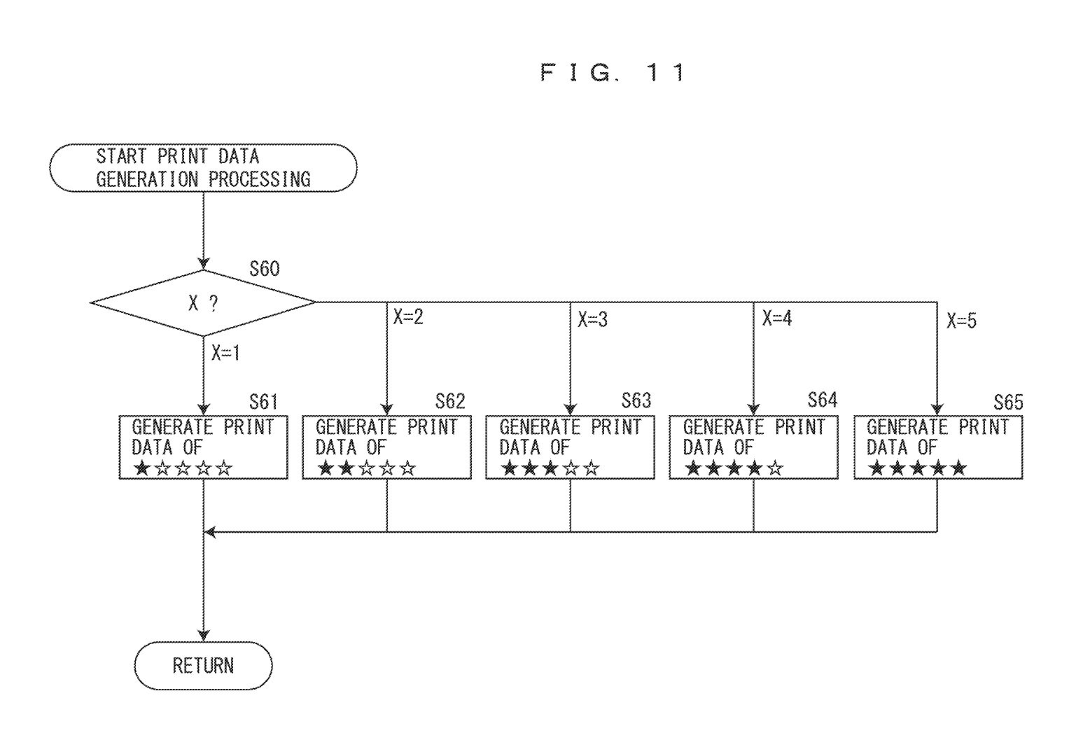

As shown in FIG. 11, with the start of the print data generation processing, the print data generation section 22 refers to the variable X stored in the memory (S60) and generates the print data of the evaluation image L corresponding to the value of the variable X (S61 to S65). For example, when the variable X is three, the print data generation section 22 generates the print data of the evaluation image L in which the number of the first stars Ea (★) is three (S63). Thus, the print data generation section 22 generates the print data of the evaluation image L set in the rank setting processing. Note that the print data generation section 22 combines the evaluation image L with the pictogram B set in the pictogram setting processing and the text C set in the text setting processing to generate the print data. After that, the tape printer 1 ends the print data generation processing and returns to the rank label creation menu.

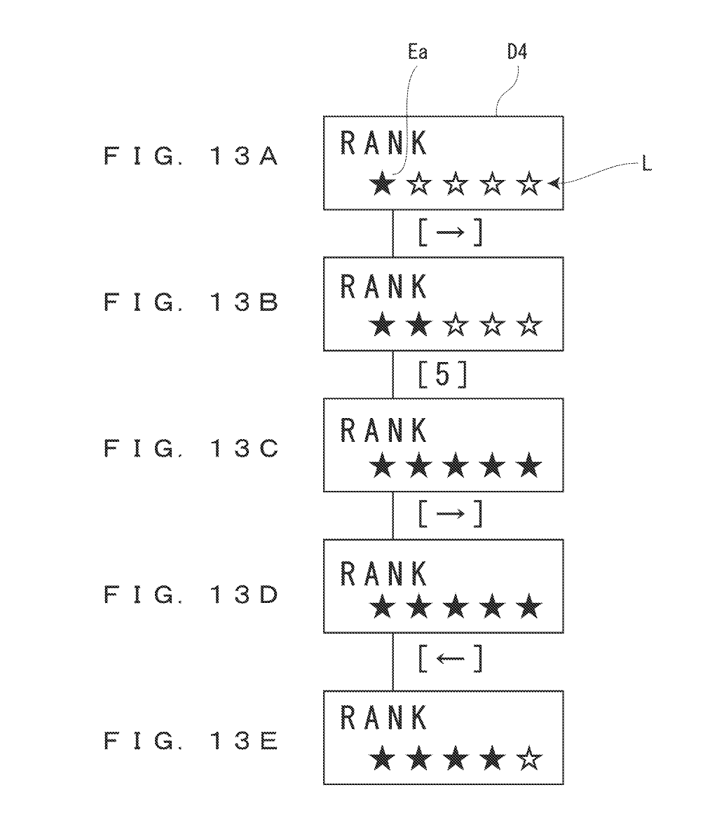

A description will be given, with reference to FIG. 9 and by the use of FIGS. 13A to 13E, in more detail of screen transition in the rank setting processing.

As shown in FIG. 13A, the evaluation image L in which the number of the first stars Ea (★) is one is displayed on the rank setting screen D4. When the user operates the right cursor key 31a in this state (S43; Yes), the evaluation image L in which the number of the first stars Ea (★) is two is displayed as shown in FIG. 13B (S46) since the variable X is one here (S44; Yes). Subsequently, when the user operates the numeric key 32 of “5” (S51; Yes), the evaluation image L in which the number of the first stars Ea (★) is five is displayed as shown in FIG. 13C (S53). Next, when the user operates the right cursor key 31a (S43; Yes), the evaluation image L in which the number of the first stars Ea (★) is five remains displayed as shown in FIG. 13D since the variable X is five here (S44; No). Then, when the user operates the left cursor key 31b (S47; Yes), the evaluation image L in which the number of the first stars Ea (★) is four is displayed as shown in FIG. 13E (S50) since the variable X is five here (S48; Yes).

As described above, the tape printer 1 of the embodiment changes the evaluation image L to the evaluation image L in which the number of the first stars Ea (★) is incremented in the right direction when the user operates the right cursor key 31a that indicates the right direction in a state in which the evaluation image L is displayed on the display 9. In addition, the tape printer 1 changes the evaluation image L to the evaluation image L in which the number of the second stars Eb (⋆) is incremented in the left direction when the user operates the left cursor key 31b that indicates the left direction in a state in which the evaluation image L is displayed on the display 9. Thus, the user is allowed to intuitively perform an operation to change the evaluation image L selectively displayed on the display 9 with the right cursor key 31a and the left cursor key 31b. Accordingly, the tape printer 1 may improve operability for inputting the evaluation image L that indicates the evaluation rank based on the number of the first stars Ea (★).

The tape printer 1 of the embodiment may change the evaluation image L with the right cursor key 31a and the left cursor key 31b. Therefore, there is no need to provide a dedicated operation section to change the evaluation image L independently of the right cursor key 31a and the left cursor key 31b.

As described above, in a state (on the pictogram selection screen D2) in which the plurality of pictograms B is displayed on the display 9, the lower cursor key 31c functions like the right cursor key 31a and the upper cursor key 31d functions like the left cursor key 31b. On the other hand, when the user operates the lower cursor key 31c in a state in which the evaluation image L is displayed on the display 9, it appears that the evaluation image L is changed to the evaluation image L in which the number of the first stars Ea (★) is decremented, i.e., the lower cursor key 31c functions like the left cursor key 31b due to its directivity. Therefore, the user has difficulty in finding how the evaluation image L is changed when operating the lower cursor key 31c to move the cursor in the lower direction not coincident with the arrangement direction of the stars E in a state in which the evaluation image L is displayed on the display 9. The same applies to the upper cursor key 31d.

In this regard, the tape printer 1 of the embodiment does not change the evaluation image L even if the user operates the lower cursor key 31c and the upper cursor key 31d in a state in which the evaluation image L is displayed on the display 9. Thus, the tape printer 1 may prevent the evaluation image L from being changed despite a user's intention.

The tape printer 1 of the embodiment changes the evaluation image L with the operation of the numeric keys 32. Accordingly, the user is allowed to change the evaluation image L by simply operating the numeric keys 32.

The tape printer 1 of the embodiment changes the evaluation image L in a non-cyclic way with the operation of the right cursor key 31a and the left cursor key 31b. For example, even in a case in which the user falsely operates the right cursor key 31a five times when being initially aimed at operating the right cursor key 31a four times to change the evaluation image L in which the number of the first stars Ea (★) is one to the evaluation image L in which the number of the stars Ea (★) is five (maximum), the tape printer 1 may change the evaluation image L to the evaluation image L in which the number of the first stars Ea (★) is five rather than changing the same to the evaluation image L in which the number of the first stars Ea (★) is one (minimum).

Note that the present invention is not limited to the embodiment described above but is, of course, capable of employing various other configurations without departing from the spirit thereof. For example, the embodiment may be modified into the following modes.

The arrangement direction of the stars E that constitute the evaluation image L is not particularly limited but may include, for example, a vertical direction. In this case, the tape printer 1 may change the evaluation image L with the operation of the lower cursor key 31c and the upper cursor key 31d. The number of the stars E that constitutes the evaluation image L is not particularly limited but may include, for example, three and ten.

All the stars E that constitute the evaluation image L may be placed in one of the first stars Ea (★) and the second stars Eb (⋆). That is, the tape printer 1 may be capable of printing the evaluation image L (⋆⋆⋆⋆⋆) in which the number of the first stars Ea (★) is zero.

The evaluation characters that constitute the evaluation image L are not limited to the stars E (★ and ⋆) but may include, for example, circles and ◯) and squares (▪ and □). In addition, the combination of the first mode and the second mode of the evaluation characters is not limited to the combination of a character coated with paint and a character printed in white but may include, for example, the combination of different symbols such as ⋆ and ◯ and the combination of a character and a space (blank character).

The right cursor key 31a may indicate the right direction with an arrow or the like displayed on the right cursor key 31a itself or may indicate the right direction with the shape itself of the right cursor key 31a. The same applies to the left cursor key 31b.

A first direction operation section to change the evaluation image L to the evaluation image L in which the number of the first stars Ea (★) is incremented by one in the right direction may be provided independently of the right cursor key 31a. In addition, a second direction operation section to change the evaluation image L to the evaluation image L in which the number of the second stars Ea (⋆) is incremented by one in the left direction may be provided independently of the left cursor key 31b.

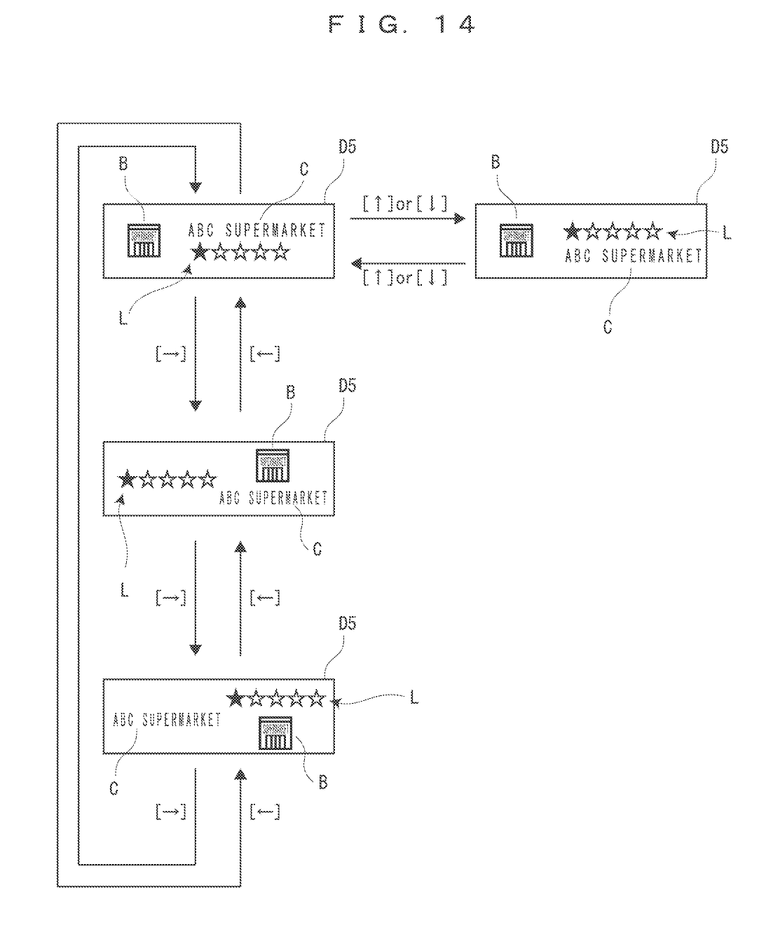

As shown in FIG. 14, the tape printer 1 may be capable of displaying, on the display 9, an edit screen D5 to edit a position in which the pictogram B, the text C, and the evaluation image L are printed on the tape Tp. For example, when the user operates the lower cursor key 31c or the upper cursor key 31d on the edit screen D5, the text C and the evaluation image L change places. In addition, when the user operates the right cursor key 31a on the edit screen D5, each of the pictogram B, the text C, and the evaluation image L rotates right-handed (clockwise) once. When the user operates the left cursor key 31b on the edit screen D5, each of the pictogram B, the text C, and the evaluation image L rotates left-handed (counterclockwise) once.

What is claimed is:

1. A tape printer comprising:
a display section that selectively displays one of a plurality of evaluation images, each of which has a plurality of evaluation characters and indicates a different evaluation rank, based on the number of the evaluation characters placed in a first mode among the plurality of evaluation characters at least some of which are capable of being individually placed in one of the first mode and a second mode;
a first operation section used to operate the evaluation image in a first direction oriented from one end to the other end of the evaluation image displayed on the display section;
a second operation section used to operate the evaluation image in a second direction oriented from the other end to the one end of the evaluation image displayed on the display section;
an image change section that changes the evaluation image to another evaluation image in which the number of the evaluation characters placed in the first mode is incremented in the first direction when the first operation section is operated in a state in which the evaluation image is displayed on the display section, and changes the evaluation image to another evaluation image in which the number of the evaluation characters placed in the second mode is incremented in the second direction when the second operation section is operated in a state in which the evaluation image is displayed on the display section; and
a print data generation section that generates print data of the displayed evaluation image.

2. The tape printer according to claim 1, wherein
the first operation section includes a first cursor operation section used to move a cursor displayed on the display section in the first direction, and
the second operation section includes a second cursor operation section used to move the cursor displayed on the display section in the second direction.

3. The tape printer according to claim 2, further comprising:
a third cursor operation section used to move the cursor displayed on the display section in a third direction different from the first direction and the second direction; and
a fourth cursor operation section used to move the cursor displayed on the display section in a fourth direction different from the first direction, the second direction, and the third direction, wherein
the first cursor operation section and the third cursor operation section are used to switch a selected one of a plurality of alternatives to another alternative next to the selected alternative in the first direction, the plurality of alternatives being displayed side by side in a same direction as an arrangement direction of the plurality of evaluation characters,
the second cursor operation section and the fourth cursor operation section are used to switch the selected one of the plurality of alternatives to another alternative next to the selected alternative in the second direction, and
the image change section does not change the evaluation image when the third cursor operation section is operated and does not change the evaluation image when the fourth cursor operation section is operated in a state in which the evaluation image is displayed on the display section.

4. The tape printer according to claim 1, further comprising:
a plurality of numeric operation sections used to individually input a plurality of types of numeric characters, wherein,
when one of the plurality of the numeric operation sections is operated in a state in which the evaluation image is displayed on the display section, the image change section changes the evaluation image to another evaluation image in which the evaluation characters corresponding to a numeric character of the operated numeric operation section are placed in the first mode.

5. The tape printer according to claim 1, wherein
the image change section does not change the evaluation image to another evaluation image in which the number of the evaluation characters placed in the first mode is minimum when the first operation section is operated in a state in which the evaluation image in which the number of the evaluation characters placed in the first mode is maximum is displayed on the display section, and does not change the evaluation image to another evaluation image in which the number of the evaluation characters placed in the first mode is maximum when the second operation section is operated in a state in which the evaluation image in which the number of the evaluation characters placed in the first mode is minimum is displayed on the display section.

6. A method of generating print data in a tape printer, method comprising:
selectively displaying one of a plurality of evaluation images, each of which has a plurality of evaluation characters and indicates an evaluation rank, based on the number of the evaluation characters placed in a first mode among the plurality of evaluation characters at least some of which are capable of being individually placed in one of the first mode and a second mode;
changing the evaluation image to another evaluation image in which the number of the evaluation characters placed in the first mode is incremented in a first direction when a first operation section is operated in a state in which the evaluation image is displayed on the display section, the first operation section being used to operate the evaluation image in the first direction oriented from one end to the other end of the evaluation image displayed on the display section;
changing the evaluation image to another evaluation image in which the number of the evaluation characters placed in the second mode is incremented in a second direction when a second operation section is operated in a state in which the evaluation image is displayed on the display section, the second operation section being used to operate the evaluation image in the second direction oriented from the other end to the one end of the evaluation image displayed on the display section; and
generating print data of the displayed evaluation image.
